(19) United States
(12) Patent Application Publication
(10) Pub. No.: US 2023/0232446 A1
(43) Pub. Date: Jul. 20, 2023

(54) CHANNEL ACCESS SELECTION METHOD AND APPARATUS, COMMUNICATION DEVICE, AND READABLE STORAGE MEDIUM

(71) Applicant: VIVO MOBILE COMMUNICATION CO., LTD., Dongguan (CN)

(72) Inventor: Lei JIANG, Dongguan (CN)

(73) Assignee: VIVO MOBILE COMMUNICATION CO., LTD., Dongguan (CN)

(21) Appl. No.: 18/125,719

(22) Filed: Mar. 23, 2023

Related U.S. Application Data
(63) Continuation of application No. PCT/CN2021/120361, filed on Sep. 24, 2021.

(30) Foreign Application Priority Data
Sep. 25, 2020 (CN) 20201023460.8

(51) Int. Cl. H04W 74/02; H04W 16/14

(52) U.S. Cl. CPC H04W 74/02; H04W 16/14

(57) ABSTRACT

A channel access selection method and apparatus, a communication device, and a readable storage medium, are provided. The channel access selection method includes: the communication device obtains first information and selects a channel access mechanism for an unlicensed band according to the first information. The first information includes statistical information of a channel’s historic state, a transmission type, a transmission priority, or the like.

### CROSS-REFERENCE TO RELATED APPLICATIONS

This application is a continuation of International Application No. PCT/CN2021/120361, filed on Sep. 24, 2021, which claims priority to Chinese Patent Application No. 202011023460.8, filed on Sep. 25, 2020. The entire contents of each of the above-identified applications are expressly incorporated herein by reference.

### TECHNICAL FIELD

This application pertains to the field of communications technologies, and in particular, to a channel access selection method and apparatus, a communication device, and a readable storage medium.

### BACKGROUND

In a communications system, a shared spectrum, for example, an unlicensed band, can be used as a supplement to a licensed band to help an operator expand a service. The unlicensed band may work in multiple bands, such as 5 GHz, 37 GHz, and 60 GHz bands. At present, to meet various requirements, for the unlicensed band, a Listen Before Talk (LBT) channel access mechanism or a non-LBT channel access mechanism may be selected. However, it is not clearly specified on how to select a channel access mechanism for the unlicensed band.

### SUMMARY

Embodiments of this application provide a channel access selection method and apparatus, a communication device, and a readable storage medium, to resolve a problem of how to select a channel access mechanism for an unlicensed band.

According to a first aspect, a channel access selection method is provided, and the method includes:
a communication device obtains first information; and
the communication device selects a channel access mechanism for an unlicensed band according to the first information.

According to a second aspect, a channel access selection apparatus is provided, and the apparatus includes:
an obtaining module, configured to obtain first information; and
a selecting module, configured to select a channel access mechanism for an unlicensed band according to the first information.

According to a third aspect, a communication device is provided, where the communication device includes a processor, a memory, and a program or an instruction that is stored in the memory and that can run on the processor, and when the program or the instruction is executed by the processor, the steps of the method according to the first aspect are implemented.

According to a fourth aspect, a readable storage medium is provided, where the readable storage medium stores a program or an instruction, and when the program or the instruction is executed by a processor, the steps of the method according to the first aspect are implemented.

According to a fifth aspect, a chip is provided, where the chip includes a processor and a communication interface, the communication interface is coupled to the processor, and the processor is configured to run a program or an instruction to implement the method according to the first aspect.

In this embodiment of this application, the communication device, such as the terminal or the network side device, may obtain the first information and select the channel access mechanism for the unlicensed band according to the first information. The first information, for example, includes but is not limited to the statistical information of the channel’s historic state, the transmission type, the transmission priority, or the like.

### BRIEF DESCRIPTION OF DRAWINGS

FIG. 1 is a block diagram of a wireless communications system according to an embodiment of this application;

FIG. 2 is a flowchart of a channel access selection method according to an embodiment of this application;

FIG. 3 is a schematic structural diagram of a channel access selection apparatus according to an embodiment of this application;

FIG. 4 is a schematic structural diagram of a communication device according to an embodiment of this application;

FIG. 5 is a schematic structural diagram of a terminal according to an embodiment of this application; and

FIG. 6 is a schematic structural diagram of a network side device according to an embodiment of this application.

### DETAILED DESCRIPTION

The following describes the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

The terms “first,” “second,” and the like in this specification and claims of this application are used to distinguish between similar objects instead of describing a specific order or sequence. It should be understood that, data used in this way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and a character “/” generally represents an “or” relationship between associated objects.

It should be noted that the technology described in the embodiments of this application is not limited to a Long Term Evolution (LTE)/LTE-Advanced (LTE-A) system, and may also be used in various wireless communication systems, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” in the embodiments of this application may be used interchangeably. The described technologies can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6th Generation (6G) communications system.

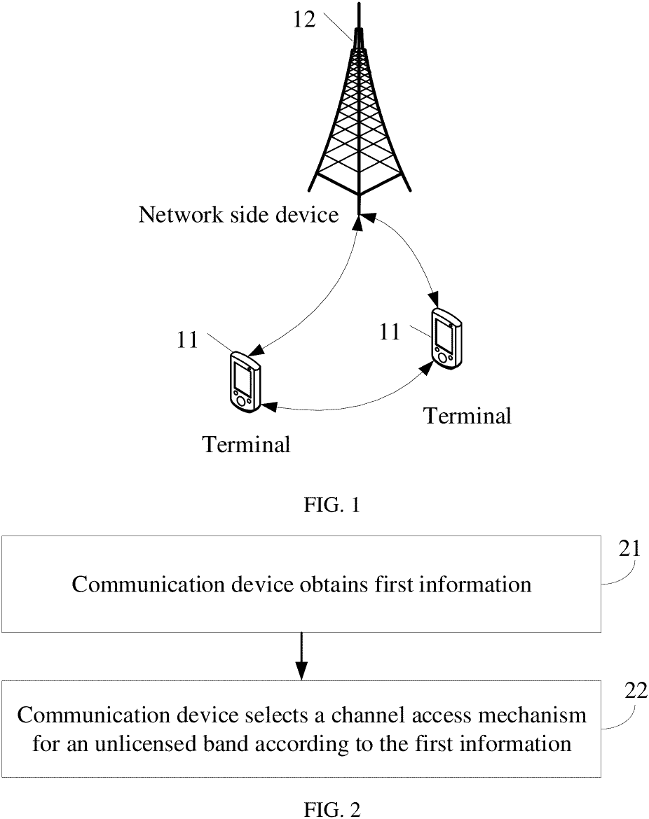

FIG. 1 is a block diagram of a wireless communications system to which embodiments of this application can be applied. The wireless communications system includes a terminal 11 and a network side device 12. The terminal 11 may also be referred to as a terminal device or User Equipment (UE). The terminal 11 may be a terminal side device such as a mobile phone, a tablet personal computer, a laptop computer, or a notebook computer, a Personal Digital Assistant (PDA), a palmtop computer, a netbook, an Ultra-Mobile Personal Computer (UMPC), a Mobile Internet Device (MID), a wearable device, or a Vehicle User Equipment (VUE), or Pedestrian User Equipment (PUE). The wearable device includes a band, a headset, eyeglasses, or the like. It should be noted that a specific type of the terminal 11 is not limited in the embodiments of this application. The network side device 12 may be a base station or a core network. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a WLAN access point, a Wi-Fi node, a Transmission and Reception Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

With reference to the accompanying drawings, the channel access selection method provided in the embodiments of this application is described in detail by using specific embodiments and application scenarios.

Referring to FIG. 2, FIG. 2 is a flowchart of a channel access selection method provided by an embodiment of this application, which is applied to a communication device, and the communication device may be a terminal or a network side device. As shown in FIG. 2, the method includes the following steps.

Step 21: A communication device obtains first information.

In this embodiment of this application, the first information may include, but is not limited to, at least one of the following:
statistical information of a channel’s historic state;
a transmission type or transmission priority;
feedback information of a Hybrid Automatic Repeat reQuest (HARQ) or a data retransmission ratio; or
a received power of a signal or interference level related information. It should be noted that the received power of a signal or interference level related information represents information about a communication peer. That is, a terminal may select a channel access mechanism for an unlicensed band according to the received power of a signal or interference level related information of a network side device; and the network side device may select a channel access mechanism for an unlicensed band according to a received power of a signal or interference level related information of the terminal. The received power of a signal is, for example, a Reference Signal Received Power (RSRP).

In some implementations, the statistical information of the channel’s historic state may include, but is not limited to, at least one of the following related parameters: a channel access success rate, a channel access failure rate, a channel occupancy rate, a cache data volume, or the like.

In some implementations, the interference level related information may include, but is not limited to, at least one of the following related parameters: a Signal to Interference plus Noise Ratio (SINR), a Channel Quality Indicator (CQI), or the like.

Step 22: The communication device selects a channel access mechanism for an unlicensed band according to the first information.

In some implementations, the channel access mechanism for the unlicensed band in this embodiment may be an LBT channel access mechanism or a non-LBT channel access mechanism. The LBT channel access mechanism may include, but is not limited to, an omni-directional LBT channel access mechanism, a directional LBT channel access mechanism, a receiver assisted LBT channel access mechanism, or the like. The non-LBT channel access mechanism may include, but is not limited to, a no-LBT direct channel access mechanism, a long-term sensing channel access mechanism, or the like. These different channel access mechanisms may be applied to different scenarios.

In an implementation, the terminal may report a channel access mechanism that can be supported.

It can be understood that, after the channel access mechanism for the unlicensed band is selected, if a channel access mechanism selected by the communication device is inconsistent with a current channel access mechanism, a new channel access mechanism, that is, the selected channel access mechanism, is switched to; or if the channel access mechanism selected by the communication device is consistent with the current channel access mechanism, the current channel access mechanism is still used.

According to the channel access selection method in this embodiment of this application, the communication device, such as the terminal or the network side device, may obtain the first information and select the channel access mechanism for the unlicensed band according to the first information. The first information, for example, includes but is not limited to the statistical information of the channel’s historic state, the transmission type, the transmission priority, or the like. Therefore, a problem of how to select the channel access mechanism for the unlicensed band may be solved, so that the terminal or the network side device may flexibly select the channel access mechanism for the unlicensed band in different scenarios, thereby improving the overall performance of the system.

That is, in this embodiment of this application, the terminal may select the channel access mechanism for the unlicensed band by itself, and the network side device may also select the channel access mechanism for the unlicensed band by itself. In addition, the channel access mechanism for the terminal may also be indicated by the network side device.

In some implementations, if the communication device is the network side device, the selecting the channel access mechanism for the unlicensed band in step 22 may include: the network side device selects the channel access mechanism for the unlicensed band for the terminal. Afterwards, the network side device may send first indication information to the terminal. The first indication information is used to indicate channel access of the unlicensed band selected for the terminal. The first indication information may be Downlink Control Information (DCI), Radio Resource Control (RRC), signaling, broadcast signaling, or the like. That is, the network side device may indicate, through the RRC signaling, DCI, broadcast signaling, or the like, to the terminal the channel access for the unlicensed band selected for the terminal.

Further, in a case that the channel access mechanism for the terminal is indicated by the network side device, the terminal may feed back decision-related information, such as the first information, to the network side device. The obtaining the first information in step 22 may include: the network side device receives first information reported by the terminal.

In some implementations, in a case that the channel access mechanism for the terminal is indicated by the network side device, the terminal may receive the first indication information sent by the network side device, where the first indication information is used to indicate the channel access mechanism for the unlicensed band selected by the network side device for the terminal. The first indication information may be the DCI, RRC signaling, broadcast signaling, or the like. Further, the terminal may further feed back decision-related information to the network side device, for example, the terminal reports the first information to the network side device, so that the network side device selects the channel access mechanism for the unlicensed band for the terminal according to the first information.

In this embodiment of this application, for example, the communication device may send second indication information to a communication peer, the second indication information is used to explicitly or implicitly indicate to the communication peer a channel access mechanism for the communication device, and the channel access mechanism is selected by the communication device for itself. That is, the UE may explicitly or implicitly indicate to a gNB a channel access mechanism selected by the UE, and the gNB may explicitly or implicitly indicate to the UE a channel access mechanism selected by the gNB.

In an implementation, in a case that the UE selects the receiver assisted LBT channel access mechanism, the UE will explicitly or implicitly indicate to the gNB that a channel access mechanism selected by the UE is the receiver assisted LBT channel access mechanism, so as to obtain peer-to-peer assistance during channel access.

In another implementation, in a case that the gNB selects the receiver assisted LBT channel access mechanism, the gNB will explicitly or implicitly indicate to the UE that a channel access mechanism selected by the gNB is the receiver assisted LBT channel access mechanism, so as to obtain the peer-to-peer assistance during channel access.

In some implementations, in a case that the second indication information explicitly indicates the channel access mechanism to the communication peer, the second indication information may include, but is not limited to, at least one of the following: the uplink control information, downlink control information, RRC signaling, broadcast signaling, or the like.

In some implementations, in a case that the second indication information implicitly indicates the channel access mechanism to the communication peer, the second indication information may include but is not limited to at least one of the following: a correspondence between the channel access mechanism and Semi-Persistent Scheduling (SPS) configuration information, a correspondence between the channel access mechanism and Configured Grant (CG) configuration information, a correspondence between the channel access mechanism and a DeModulation Reference Signal (DMRS), or the like. In this case, according to these correspondences, the communication device selects a corresponding channel access mechanism for the unlicensed band by using a specific SPS or CG configuration among multiple configurations and/or combining the DMRS.

In some implementations, a time at which the channel access mechanism indicated by the first indication information or the second indication information takes effect may include any one of the following:

(1) a first time unit after a first time period from a time at which the first indication information or the second indication information is sent.

In (1), the time unit may be, but is not limited to, a symbol, a time slot, a subframe, or the like. For example, the first time period is represented by P1 time units. Duration of the first time period may be a predefined or pre-configured value, or a value based on terminal capability feedback.

(2) A first time unit after a second time period from a time at which feedback information of the first indication information or the second indication information is received.

In (2), the time unit may be, but is not limited to, a symbol, a time slot, a subframe, or the like. For example, the second time period is represented by P2 time units. Duration of the first time period may be a predefined or pre-configured value, or a value based on terminal capability feedback.

That is, in this embodiment of this application, in a case that the gNB indicates the channel access mechanism to the UE or the UE indicates the channel access mechanism to the gNB, besides explicit indication, the channel access mechanism may be implicitly indicated by adopting the specific SPS or CG configuration among the multiple configurations for transmission. These specific configurations may be configured on a reserved resource by the gNB, or a relatively low Modulation and Coding Scheme (MCS) may be configured, to ensure that a receive end can perform receiving correctly. In some implementations, the receive end feeds back ACK to a transmit end to confirm receiving of information related to the channel access mechanism. The transmit end and the receive end start to use a new channel access mechanism in a first time unit (such as a symbol, time slot, or subframe) after P1 time units after explicit or implicit indication of the channel access mechanism, or start to use a new channel access mechanism in a first time unit (such as a symbol, time slot, or subframe) after P2 time units after ACK feedback.

In some implementations, the communication device may select the channel access mechanism for the unlicensed band according to predefined information or pre-configured information. That is, in this application, a default channel access mechanism may be predefined or pre-configured, so that the terminal or the network side device may use the default channel access mechanism before receiving the channel access mechanism indication or selecting the channel access mechanism according to the obtained first information.

According to a difference in content included in the first information, a selection criteria for the channel access mechanism will be explained in detail below based on different situations.

Situation 1: The first information includes the statistical information of the channel’s historic state.

In the Situation 1, a way in which the communication device selects the channel access mechanism for the unlicensed band may include at least one of the following:
I. the communication device selects a non-LBT channel access mechanism in a case that a channel access success rate in a third time period is greater than a first threshold, or a channel access failure rate in the third time period is less than a second threshold;
II. the communication device selects an LBT channel access mechanism in a case that a channel access success rate in a fourth time period is less than a third threshold, or a channel access failure rate in the fourth time period is greater than a fourth threshold;
III. the communication device selects an LBT channel access mechanism in a case that a channel occupancy rate in a fifth time period is greater than a fifth threshold;
IV. the communication device selects a non-LBT channel access mechanism in a case that a channel occupancy rate in a sixth time period is less than a sixth threshold; or
V. the communication device selects a non-LBT channel access mechanism in a case that a cache data volume in a seventh time period is greater than a seventh threshold.

In some implementations, duration of the third time period, the fourth time period, the fifth time period, the sixth time period, and the seventh time period may be the same or different. A unit of the third time period, the fourth time period, the fifth time period, the sixth time period, and the seventh time period may be selected as a second s, a millisecond ms, a time slot, or the like. The first threshold, the second threshold, the third threshold, the fourth threshold, the fifth threshold, the sixth threshold, and the seventh threshold may be the same or different, and may be set based on actual requirements, such as being configured by the network side device through the RRC signaling.

Situation 2: The first information includes the transmission type or transmission priority.

In the Situation 2, a way in which the communication device selects the channel access mechanism for the unlicensed band may include at least one of the following:
I. the communication device selects a non-LBT channel access mechanism for high-priority transmission, and selects an LBT channel access mechanism for low-priority transmission;
II. the communication device selects a non-LBT channel access mechanism for configured grant CG transmission or semi-persistent scheduling SPS transmission, and selects an LBT channel access mechanism for dynamic grant transmission; for example, the UE may select the non-LBT channel access mechanism for CG UpLink (UL) transmission; for another example, the gNB may select the non-LBT channel access mechanism for SPS DownLink (DL) transmission;
III. the communication device selects the receiver assisted LBT channel access mechanism for high reliability transmission;
IV. the communication device selects a high-priority LBT channel access mechanism for configured grant CG transmission or semi-persistent scheduling transmission, and selects a low-priority LBT channel access mechanism for dynamic grant transmission; for example, the UE may select the high-priority LBT channel access mechanism for CG UL transmission; for another example, the gNB may select the high-priority LBT channel access mechanism for SPS DL transmission; or
V. the communication device selects an LBT channel access mechanism with a low energy detection threshold for high reliability transmission, for example, compared with a current channel access mechanism, the communication device selects a lower energy detection threshold for LBT channel access.

Situation 3: the first information includes feedback information of the HARQ or a data retransmission ratio.

In the Situation 3, a way in which the communication device selects the channel access mechanism for the unlicensed band may include at least one of the following:
I. the communication device selects an LBT channel access mechanism in a case that a proportion of Negative ACKnowledgment (NACK) information in feedback information of a HARQ in an eighth time period is greater than an eighth threshold, or a data retransmission ratio in the eighth time period is greater than a ninth threshold; and
II. the communication device selects a non-LBT channel access mechanism in a case that a proportion of acknowledgment ACK information in feedback information of a HARQ in a ninth time period is greater than a tenth threshold, or a data retransmission ratio in the ninth time period is less than an eleventh threshold.

In some implementations, duration of the eighth time period and the ninth time period may be the same or different. A unit of the eighth time period and the ninth time period may be selected as a second (s), a millisecond (ms), a time slot, or the like. The eighth threshold, ninth threshold, tenth threshold, and eleventh threshold may be the same or different, and may be set based on actual requirements, such as being configured by the network side device through the RRC signaling.

Situation 4: The first information includes a received power of a signal or interference level related information.

In the Situation 4, a way in which the communication device selects the channel access mechanism for the unlicensed band may include at least one of the following:
I. the communication device selects an LBT channel access mechanism in a consecutive tenth time period in a case that a received power of a signal of the communication peer is less than a twelfth threshold or an interference power of a signal of the communication peer is greater than a thirteenth threshold; and
II. the communication device selects a non-LBT channel access mechanism in a consecutive eleventh time period in a case that a received power of a signal of the communication peer is greater than a fourteenth threshold or an interference power of a signal of the communication peer is less than a fifteenth threshold.

In some implementations, duration of the tenth time period and the eleventh time period may be the same or different. A unit of the tenth time period and the eleventh time may be selected as a second (s), a millisecond (ms), a time slot, or the like. The twelfth threshold, thirteenth threshold, fourteenth threshold, and fifteenth threshold may be the same or different, and may be set based on actual requirements, such as being configured by the network side device through the RRC signaling.

It should be noted that in the first situation, third situation, and fourth situation, by setting different thresholds, the communication device performs selection between the receiver assisted LBT channel access mechanism and a common LBT channel access mechanism, or performs selection between the long-term sensing channel access mechanism and the non-LBT channel access mechanism. The common LBT channel access mechanism includes the directional LBT channel access mechanism, the omni-directional LBT channel access mechanism, and the like.

In this embodiment of this application, “greater than” may be replaced by “greater than or equal to” and “less than” may be replaced by “less than or equal to”.

This application is described below in detail with reference to specific embodiments.

### Embodiment 1

In the Embodiment 1, if the gNB or UE currently uses the LBT channel access mechanism, the LBT channel access mechanism may be switched to the long-term sensing channel access mechanism in a case that a channel access success rate in T ms is greater than ×1%. In some implementations, if the gNB or UE currently uses the LBT channel access mechanism or the long-term sensing channel access mechanism, the no-LBT channel access mechanism may be switched to in a case that the channel access success rate in T ms is greater than ×2%. ×2>×1.

If the gNB or UE currently uses the LBT channel access mechanism, the LBT channel access mechanism may be switched to the long-term sensing channel access mechanism in a case that the channel access failure rate, that is, a rate of channel access failure, in T ms is greater than or less than ×1 ′%. In some implementations, if the gNB or UE currently uses the LBT channel access mechanism or the long-term sensing channel access mechanism, the no-LBT channel access mechanism may be switched to in a case that the channel access failure rate in T ms is greater than ×2 ′%. ×2′<×1′.

If the gNB or UE currently uses the long-term sensing channel access mechanism, the long-term sensing channel access mechanism may be switched to the LBT channel access mechanism in a case that the channel access success rate in T ms is less than y1%.

If the gNB or UE currently uses the long-term sensing channel access mechanism, the long-term sensing channel access mechanism may be switched to the LBT channel access mechanism in a case that the channel access failure rate in T ms is greater than y1′%.

If the gNB or UE currently uses the no-LBT channel access mechanism, the non-LBT channel access mechanism may be switched to the long-term sensing channel access mechanism in a case that a channel occupancy rate in T ms is greater than z1%. In some implementations, if the gNB or UE currently uses the no-LBT channel access mechanism or the long-term sensing channel access mechanism, the LBT channel access mechanism may be switched to in a case that the channel occupancy rate in T ms is greater than z2%. z2>z1.

If the gNB or UE currently uses the LBT channel access mechanism, the LBT channel access mechanism may be switched to the long-term sensing channel access mechanism in a case that the channel occupancy rate in T ms is less than z1′%. In some implementations, if the gNB or UE currently uses the LBT channel access mechanism or long-term sensing channel access mechanism, the no-LBT channel access mechanism may be switched to win a case that the channel occupancy rate in T ms is less than z2′%. z2′<z1′.

If the gNB or UE currently uses the LBT channel access mechanism, the LBT channel access mechanism may be switched to the long-term sensing channel access mechanism in a case that a cache data volume in T ms is greater than D1. In some implementations, if the gNB or UE currently uses the LBT channel access mechanism or the long-term sensing channel access mechanism, the no-LBT channel access mechanism may be switched to in a case that the cache data volume in T ms is greater than D2. D2>D1.

If the gNB or UE currently uses the no-LBT channel access mechanism, the non-LBT channel access mechanism may be switched to the long-term sensing channel access mechanism in a case that the cache data volume in T ms is less than D1′. In some implementations, if the gNB or UE currently uses the no-LBT channel access mechanism or the long-term sensing channel access mechanism, the LBT channel access mechanism may be switched to in a case that the cache data volume in T ms is less than D2′. D2′<D1′.

It should be noted that a value of T in the foregoing different situations may be the same or different.

### Embodiment 2

In the Embodiment 2, if the gNB or UE currently uses the no-LBT channel access mechanism, the long-term sensing channel access mechanism may be switched to in a case that a HARQ greater than h1% in T1 ms is NACK, or the data retransmission ratio exceeds r1%. In some implementations, if the gNB or UE currently uses the no-LBT channel access mechanism or long-term sensing channel access mechanism, the common LBT channel access mechanism may be switched to in a case that a HARQ greater than h2% in T1 ms is NACK, or the data retransmission ratio exceeds r2%. In some implementations, if the gNB or UE currently uses the no-LBT channel access mechanism, long-term sensing channel access mechanism, or common LBT channel access mechanism, the receiver-assisted LBT channel access mechanism may be switched to in a case that a HARQ greater than h3% in T1 ms is NACK, or the data retransmission ratio exceeds r3%. h3>h2>h1, r3>r2>rl.

If the gNB or UE currently uses the receiver assisted LBT channel access mechanism, the common LBT channel access mechanism may be switched to in a case that a HARQ greater than h1′% in T1 ms is ACK, or the data retransmission ratio is less than r1′%. In some implementations, if the gNB or UE currently uses the receiver assisted LBT channel access mechanism or the common LBT channel access mechanism, the long-term sensing channel access mechanism may be switched to when a HARQ greater than h2′% in T1 ms is ACK or the data retransmission ratio is less than r2′%. In some implementations, if the gNB or UE currently uses the receiver assisted LBT channel access mechanism, common LBT channel access mechanism, or long-term sensing channel access mechanism, the non-LBT channel access mechanism may be switched to when a HARQ greater than h3′% in T1 ms is ACK, or the data retransmission ratio is less than r3′%. h3′>h2′>h1′, r3′<r2′<r1′.

It should be noted that a value of T1 in the foregoing different situations may be the same or different.

For the foregoing switching based on HARQ ACK/NACK, with respect to the gNB, the HARQ ACK/NACK is HARQ ACK/NACK fed back by the UE; and for the UE, the HARQ ACK/NACK may be feedback from the gNB in Downlink Feedback Information (DFI). If no DFI exists, the UE may select or adjust the channel access mechanism based on the data retransmission ratio.

### Embodiment 3

In the Embodiment 3, if the gNB currently uses the no-LBT channel access mechanism, the gNB may switch to the long-term sensing channel access mechanism in a case that at least u% of the UE has an RSRP less than a threshold TH1, an interference power of a signal greater than a threshold TH2, or a SINR/CQI less than a threshold TH3 within a consecutive time T2. In some implementations, if the gNB currently uses the no-LBT channel access mechanism or long-term sensing channel access mechanism, the gNB may switch to the common LBT channel access mechanism in a case that at least u% of the UE has the RSRP less than a threshold TH1′, the interference power of a signal greater than a threshold TH2′, or the SINR/CQI less than a threshold TH3′ within the consecutive time T2. In some implementations, if the gNB currently uses the no-LBT channel access mechanism, long-term sensing channel access mechanism, or common LBT channel access mechanism, in a case that at least u% of the UE or at least one UE has the RSRP less than a threshold TH1″, the interference power of a signal greater than a threshold TH2″, or the SINR/CQI less than a threshold TH3″ within the consecutive time T2, the gNB may switch to the receiver assisted LBT channel access mechanism, or the gNB only uses the receiver assisted LBT channel access mechanism for these UE. TH1″<TH1′<TH1, TH2″>TH2′>TH2, TH3″<TH3′<TH3.

If the gNB currently uses the receiver assisted LBT channel access mechanism, the gNB may switch to the common LBT channel access mechanism in a case that at least u% of the UE has the RSRP greater than the threshold TH1, the interference power of a signal less than the threshold TH2, or the SINR/CQI greater than the threshold TH3 within the consecutive time T2. In some implementations, if the gNB currently uses the receiver assisted LBT channel access mechanism or common LBT channel access mechanism, the gNB may switch to the long-term sensing channel access mechanism in a case that at least u% of the UE has the RSRP greater than the threshold TH1′, the interference power of a signal less than the threshold TH2′, or the SINR/CQI greater than the threshold TH3′ within the consecutive time T2. In some implementations, if the gNB currently uses the receiver-assisted LBT channel access mechanism, common LBT channel access mechanism, or long-term sensing channel access mechanism, the gNB may switch to the no-LBT channel access mechanism in a case that at least u% of the UE has the RSRP greater than the threshold TH1″, the interference power of a signal less than the threshold TH2″, or the SINR/CQI greater than the threshold TH3″ within the consecutive T2 time. TH1″>TH1′>TH1, TH2″<TH2′<TH2, TH3″>TH3′>TH3.

It should be noted that an executing body for the channel access selection method provided in this embodiment of this application may be a channel access selection apparatus or a control module in the channel access selection apparatus, for executing the channel access selection method. In this embodiment of this application, the channel access selection apparatus provided in this embodiment of this application is described by taking channel access selection apparatus executing the channel access selection method as an example.

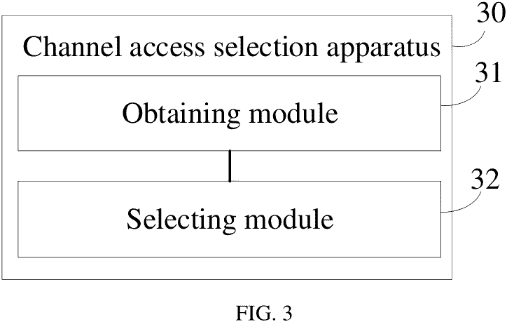

Referring to FIG. 3, FIG. 3 is a schematic structural diagram of a channel access selection apparatus provided in an embodiment of this application, the apparatus is applied to a communication device, and the communication device may be a terminal or a network side device. As shown in FIG. 3, the channel access selection apparatus 30 includes:
an obtaining module 31, configured to obtain first information; and
a selecting module 32, configured to select a channel access mechanism for an unlicensed band according to the first information.

In some implementations, the first information includes at least one of the following:
statistical information of a channel’s historic state;
a transmission type or transmission priority;
feedback information of a HARQ or a data retransmission ratio; or
a received power of a signal or interference level related information.

In some implementations, the statistical information of a channel’s historic state includes at least one of the following:
a channel access success rate;
a channel access failure rate;
a channel occupancy rate; or
a cache data volume.

In some implementations, the communication device is a network side device, and the selecting module 32 is configured to select a channel access mechanism for an unlicensed band for a terminal; and
the channel access selection apparatus 30 further includes:
a first sending module, configured to send first indication information to the terminal, where the first indication information is used to indicate the channel access mechanism selected for the terminal in the unlicensed band.

In some implementations, the obtaining module 31 is further configured to: receive first information reported by the terminal.

In some implementations, the channel access selection apparatus 30 further includes:

a second sending module, configured to send second indication information to a communication peer, where the second indication information is used to explicitly or implicitly indicate to the communication peer a channel access mechanism for the communication device.

In some implementations, when the second indication information explicitly indicates the channel access mechanism to the communication peer, the second indication information includes at least one of the following:
uplink control information, downlink control information, RRC signaling, or broadcast signaling;
or when the second indication information implicitly indicates the channel access mechanism to the communication peer, the second indication information includes at least one of the following:
   a correspondence between the channel access mechanism and SPS configuration information;
   a correspondence between the channel access mechanism and CG configuration information; or
   a correspondence between the channel access mechanism and a DMRS.

In some implementations, a time at which the channel access mechanism indicated by the first indication information or the second indication information takes effect includes any one of the following:
a first time unit after a first time period from a time at which the first indication information or the second indication information is sent; and
a first time unit after a second time period from a time at which feedback information of the first indication information or the second indication information is received.

In some implementations, the selecting module 32 is further configured to: select the channel access mechanism for the unlicensed band according to predefined information or pre-configured information.

In some implementations, the first information includes the statistical information of a channel’s historic state; and the selecting module 32 is configured to perform at least one of the following:
selecting a non-LBT channel access mechanism in a case that a channel access success rate in a third time period is greater than a first threshold, or a channel access failure rate in the third time period is less than a second threshold;
selecting an LBT channel access mechanism in a case that a channel access success rate in a fourth time period is less than a third threshold, or a channel access failure rate in the fourth time period is greater than a fourth threshold;
selecting an LBT channel access mechanism in a case that a channel occupancy rate in a fifth time period is greater than a fifth threshold;
selecting a non-LBT channel access mechanism in a case that a channel occupancy rate in a sixth time period is less than a sixth threshold; or
selecting a non-LBT channel access mechanism in a case that a cache data volume in a seventh time period is greater than a seventh threshold.

In some implementations, the first information includes a transmission type or a transmission priority, and the selecting module 32 is configured to perform at least one of the following:
selecting a non-LBT channel access mechanism for high-priority transmission, and selecting an LBT channel access mechanism for low-priority transmission;
selecting a non-LBT channel access mechanism for configured grant transmission or semi-persistent scheduling transmission, and selecting an LBT channel access mechanism for dynamic grant transmission;
selecting, for high reliability transmission, a receiver assisted LBT channel access mechanism or an LBT channel access mechanism with a low energy detection threshold; or
selecting a high-priority LBT channel access mechanism for configured grant transmission or semi-persistent scheduling transmission, and selecting a low-priority LBT channel access mechanism for dynamic grant transmission.

In some implementations, the first information includes feedback information of a HARQ or a data retransmission ratio, and the selecting module 32 is configured to perform at least one of the following:
selecting an LBT channel access mechanism in a case that a proportion of NACK information in feedback information of a HARQ in an eighth time period is greater than an eighth threshold, or a data retransmission ratio in the eighth time period is greater than a ninth threshold; or
selecting a non-LBT channel access mechanism in a case that a proportion of ACK information in feedback information of a HARQ in a ninth time period is greater than a tenth threshold, or a data retransmission ratio in the ninth time period is less than an eleventh threshold.

In some implementations, the first information includes received power of a signal or interference level related information, and the interference level related information includes an interference power of a signal. The selecting module 32 is configured to perform at least one of the following:
selecting an LBT channel access mechanism in a consecutive tenth time period in a case that a received power of a signal of the communication peer is less than a twelfth threshold or an interference power of a signal of the communication peer is greater than a thirteenth threshold; or
selecting a non-LBT channel access mechanism in a consecutive eleventh time period in a case that a received power of a signal of the communication peer is greater than a fourteenth threshold or an interference power of a signal of the communication peer is less than a fifteenth threshold.

The channel access selection apparatus in this embodiment of this application may be an apparatus, or may be a component, an integrated circuit, or a chip in a terminal. The apparatus may be a mobile terminal or a non-mobile terminal. For example, the mobile device may include but is not limited to the types of the terminal 11 listed above, and the non-mobile terminal may be a server, a Network Attached Storage (NAS), a personal computer, a television, an automated teller machine, or a self-service machine. This is not specifically limited in the embodiments of this application.

The channel access selection apparatus in this embodiment of this application may be an apparatus with an operating system. The operating system may be an Android operating system, an iOS operating system, or another possible operating system. This is not specifically limited in the embodiments of this application.

The channel access selection apparatus provided in this embodiment of this application can realize each process of the method embodiment of FIG. 2. To avoid repetition, details are not described herein again.

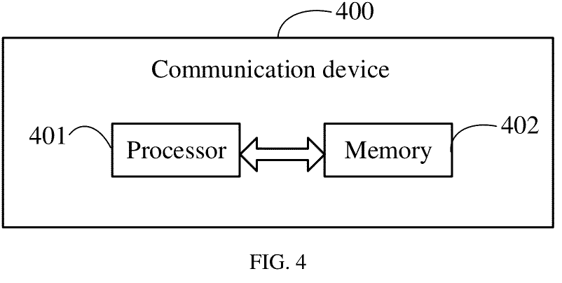

In some implementations, as shown in FIG. 4, an embodiment of this application further provides a communication device 400, including a processor 401, a memory 402, and a program or an instruction that is stored in the memory 402 and that can run on the processor 401. When the program or the instruction is executed by the processor 401, the processes of the foregoing channel access selection method are implemented. To avoid repetition, details are not described herein again. The communication device 400 may be a terminal or a network side device.

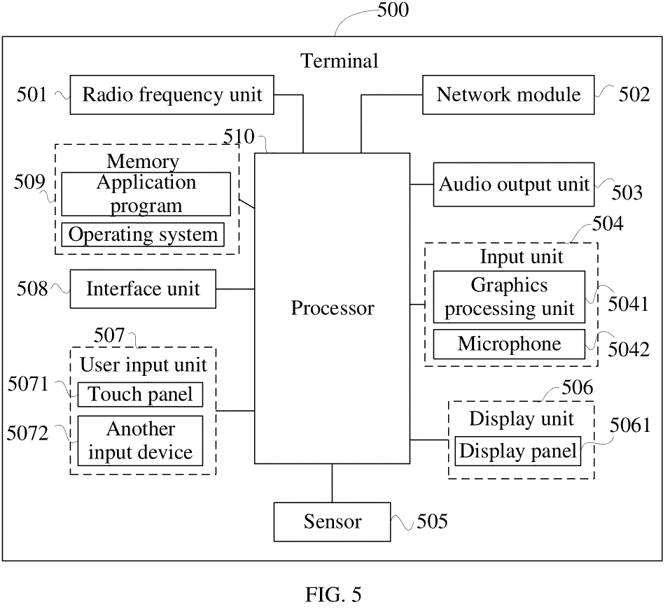

FIG. 5 is a schematic diagram of a hardware structure of a terminal according to an embodiment of this application.

The terminal 500 includes but is not limited to components such as a radio frequency unit 501, a network module 502, an audio output unit 503, an input unit 504, a sensor 505, a display unit 506, a user input unit 507, an interface unit 508, a memory 509, and a processor 510.

It may be understood by a person skilled in the art that the terminal 500 may further include a power supply (such as a battery) that supplies power to each component. The power supply may be logically connected to the processor 510 by using a power management system, to implement functions such as charging, discharging, and power consumption management by using the power management system. The terminal structure shown in FIG. 5 constitutes no limitation on the terminal, and the terminal may include more or fewer components than those shown in the figure, or combine some components, or have different component arrangements. Details are not described herein.

It should be understood that, in this embodiment of this application, the input unit 504 may include a Graphics Processing Unit (GPU) 5041 and a microphone 5042. The graphics processing unit 5041 processes image data of a static picture or a video obtained by an image capture apparatus (such as a camera) in video capture mode or image capture mode. The display unit 506 may include a display panel 5061, and the display panel 5061 may be configured in a form of a liquid crystal display, an organic light-emitting diode, or the like. The user input unit 507 includes a touch panel 5071 and another input device 5072. The touch panel 5071 is also referred to as a touchscreen. The touch panel 5071 may include two parts: a touch detection apparatus and a touch controller. The another input device 5072 may include but is not limited to a physical keyboard, a functional button (such as a volume control button or a power on/off button), a trackball, a mouse, and a joystick. Details are not described herein.

In this embodiment of this application, the radio frequency unit 501 receives downlink data from a network side device and then sends the downlink data to the processor 510 for processing; and sends uplink data to the network side device. Usually, the radio frequency unit 501 includes but is not limited to an antenna, at least one amplifier, a transceiver, a coupler, a low noise amplifier, a duplexer, and the like.

The memory 509 may be configured to store a software program or an instruction and various pieces of data. The memory 509 may mainly include a program or instruction storage area and a data storage area. The program or instruction storage area may store an operating system, and an application program or an instruction required by at least one function (for example, a sound playing function or an image playing function). In addition, the memory 509 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage component, a flash memory component, or another non-volatile solid-state storage component.

The processor 510 may include one or more processing units. In some implementations, an application processor and a modem processor may be integrated into the processor 510. The application processor mainly processes an operating system, a user interface, an application, an instruction, or the like. The modem processor mainly processes wireless communications, for example, a baseband processor. It can be understood that, in some implementations, the modem processor may not be integrated into the processor 510.

The processor 510 is configured to obtain first information, and select a channel access mechanism for an unlicensed band according to the first information. Therefore, the terminal can flexibly select the channel access mechanism for the unlicensed band in different scenarios, thereby improving the overall performance of the system.

In some implementations, the first information includes at least one of the following:
statistical information of a channel’s historic state;
a transmission type or transmission priority;
feedback information of a HARQ or a data retransmission ratio; or
a received power of a signal or interference level related information.

In some implementations, the statistical information of a channel’s historic state includes at least one of the following:
a channel access success rate;
a channel access failure rate;
a channel occupancy rate; or
a cache data volume.

It can be understood that the terminal 500 in this embodiment of this application can achieve all the processes implemented by the terminal in FIG. 2. To avoid repetition, details are not described herein again.

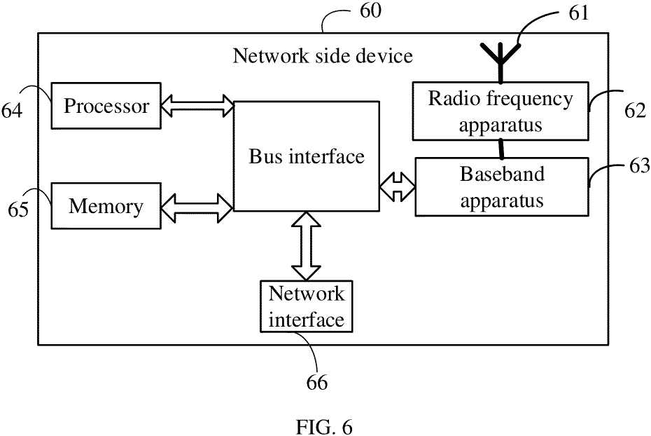

An embodiment of this application further provides a network side device. As shown in FIG. 6, the network-side device 600 includes an antenna 61, a radio frequency apparatus 62, and a baseband apparatus 63. The antenna 61 is connected to the radio frequency apparatus 62. In an uplink direction, the radio frequency apparatus 62 receives information by using the antenna 61, and transmits the received information to the baseband apparatus 63 for processing. In a downlink direction, the baseband apparatus 63 processes information that needs to be sent, and sends processed information to the radio frequency apparatus 62. The radio frequency apparatus 62 processes the received information, and sends processed information by using the antenna 61.

The frequency band processing apparatus may be located in the baseband apparatus 63. The method performed by the network side device in the foregoing embodiment may be implemented in the baseband apparatus 63. The baseband apparatus 63 includes a processor 64 and a memory 65.

For example, the baseband apparatus 63 may include at least one baseband board. Multiple chips are disposed on the baseband board. As shown in FIG. 6, one chip is, for example, the processor 64, and is connected to the memory 65, to invoke a program in the memory 65 to perform an operation of the network side device shown in the foregoing method embodiment.

The baseband apparatus 63 may further include a network interface 66, configured to exchange information with the radio frequency apparatus 62. For example, the interface is a Common Public Radio Interface (CPRI).

The network side device in this embodiment of this application further includes an instruction or a program that is stored in the memory 65 and that can run on the processor 64. The processor 64 invokes the instruction or program in the memory 65 to perform the method executed by modules with numerals of the network-side virtual apparatus in FIG. 3, and a same technical effect is achieved. To avoid repetition, details are not described herein.

An embodiment of this application further provides a readable storage medium, where the readable storage medium stores a program or an instruction, and when the program or the instruction is executed by a processor, the processes of the foregoing method embodiments shown in FIG. 2 are implemented. To avoid repetition, details are not described herein again.

The processor is a processor in the terminal in the foregoing embodiment. The readable storage medium includes a computer-readable storage medium such as a Read-Only Memory (ROM), a Random Access Memory (RAM), a magnetic disk, an optical disc, or the like.

An embodiment of this application further provides a chip, where the chip includes a processor and a communication interface, the communication interface is coupled to the processor, and the processor is configured to run a program or an instruction of a network side device to implement the processes of the method embodiment in FIG. 2. To avoid repetition, details are not described herein again.

It should be understood that the chip mentioned in the embodiment of this application can also be called a system-level chip, a system chip, a chip system, or a system on chip.

It should be noted that, in this specification, the terms “include,” “comprise,” or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In the absence of more restrictions, an element defined by the statement “including a...” does not preclude the presence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such understanding, the technical solutions of this application essentially, or the part contributing to the prior art may be implemented in a form of a software product. The computer software product is stored in a storage medium (for example, a ROM/RAM, a magnetic disk, or a compact disc), and includes several instructions for instructing a terminal (which may be a mobile phone, a computer, a server, an air conditioner, a network side device, or the like) to perform the method described in the embodiments of this application.

The embodiments of this application are described above with reference to the accompanying drawings, but this application is not limited to the foregoing specific implementation manners. The foregoing specific implementation manners are merely schematic instead of restrictive. Under enlightenment of this application, a person of ordinary skills in the art may make many forms without departing from aims and the protection scope of claims of this application, all of which fall within the protection scope of this application.

1. A channel access selection method, comprising:
obtaining, by a communication device, first information; and
selecting, by the communication device, a channel access mechanism for an unlicensed band according to the first information.

2. The method according to claim 1, wherein the first information comprises at least one of the followings:
statistical information of a channel’s historic state;
a transmission type or transmission priority;
feedback information of a Hybrid Automatic Repeat reQuest (HARQ) or a data retransmission ratio; or
a received power of a signal or interference level related information.

3. The method according to claim 2, wherein the statistical information of a channel’s historic state comprises at least one of the following:
a channel access success rate;
a channel access failure rate;
a channel occupancy rate; or
a cache data volume.

4. The method according to claim 1, wherein the communication device is a network side device, and selecting, by the communication device, a channel access mechanism for an unlicensed band according to the first information comprises:
selecting, by the network side device, the channel access mechanism for the unlicensed band for a terminal; and
after selecting, by the network side device, the channel access mechanism for the unlicensed band for a terminal, the method further comprises:
sending, by the network side device, first indication information to the terminal, wherein the first indication information is used to indicate the channel access mechanism selected for the terminal in the unlicensed band.

5. The method according to claim 4, wherein the obtaining first information comprises:
receiving, by the network side device, the first information reported by the terminal.

6. The method according to claim 1, further comprising:
sending, by the communication device, second indication information to a communication peer, wherein the second indication information is used to explicitly or implicitly indicate to the communication peer a channel access mechanism for the communication device.

7. The method according to claim 6, wherein in a case that the second indication information explicitly indicates the channel access mechanism to the communication peer, the second indication information comprises at least one of the following:
uplink control information, downlink control information, Radio Resource Control (RRC) signaling, or broadcast signaling; or
in a case that the second indication information implicitly indicates the channel access mechanism to the communication peer, the second indication information comprises at least one of the following:
a correspondence between the channel access mechanism and Semi-Persistent Scheduling (SPS) configuration information;
a correspondence between the channel access mechanism and Configured Grant (CG) configuration information; or
a correspondence between the channel access mechanism and a DeModulation Reference Signal (DMRS).

8. The method according to claim 4, wherein a time at which the channel access mechanism takes effect comprises any one of the following:
a first time unit after a first time period from a time at which the first indication information or the second indication information is sent; or
a first time unit after a second time period from a time at which feedback information of the first indication information or the second indication information is received.

9. The method according to claim 1, further comprising:
selecting, by the communication device, the channel access mechanism for the unlicensed band according to predefined information or pre-configured information.

10. The method according to claim 3, wherein the first information comprises the statistical information of a channel’s historic state, and the selecting a channel access mechanism for an unlicensed band according to the first information comprises at least one of the following:
selecting, by the communication device, a non-Listen-Before-Talk (LBT) channel access mechanism in a case that a channel access success rate in a third time period is greater than a first threshold, or a channel access failure rate in the third time period is less than a second threshold;
selecting, by the communication device, an LBT channel access mechanism in a case that a channel access success rate in a fourth time period is less than a third threshold, or a channel access failure rate in the fourth time period is greater than a fourth threshold;
selecting, by the communication device, an LBT channel access mechanism in a case that a channel occupancy rate in a fifth time period is greater than a fifth threshold;
selecting, by the communication device, a non-LBT channel access mechanism in a case that a channel occupancy rate in a sixth time period is less than a sixth threshold; or
selecting, by the communication device, a non-LBT channel access mechanism in a case that a cache data volume in a seventh time period is greater than a seventh threshold.

11. The method according to claim 2, wherein the first information comprises the transmission type or the transmission priority, and the selecting a channel access mechanism for an unlicensed band according to the first information comprises at least one of the following:
selecting, by the communication device, a non-Listen-Before-Talk (LBT) channel access mechanism for high-priority transmission, and selecting, by the communication device, an LBT channel access mechanism for low-priority transmission;
selecting, by the communication device, a non-LBT channel access mechanism for configured grant transmission or semi-persistent scheduling transmission, and selecting, by the communication device, an LBT channel access mechanism for dynamic grant transmission;
selecting, by the communication device, for high reliability transmission, a receiver assisted LBT channel access mechanism or an LBT channel access mechanism with a low energy detection threshold; or
selecting, by the communication device, a high-priority LBT channel access mechanism for configured grant transmission or semi-persistent scheduling transmission, and selecting, by the communication device, a low-priority LBT channel access mechanism for dynamic grant transmission.

12. The method according to claim 2, wherein the first information comprises the feedback information of the HARQ or the data retransmission ratio, and the selecting a channel access mechanism for an unlicensed band according to the first information comprises at least one of the following:
selecting, by the communication device, a Listen-Before-Talk (LBT) channel access mechanism in a case that a proportion of Negative ACKnowledgment (NACK) information in the feedback information of the HARQ in an eighth time period is greater than an eighth threshold, or a data retransmission ratio in the eighth time period is greater than a ninth threshold; or
selecting, by the communication device, a non-LBT channel access mechanism in a case that a proportion of ACKnowledgment (ACK) information in the feedback information of the HARQ in a ninth time period is greater than a tenth threshold, or a data retransmission ratio in the ninth time period is less than an eleventh threshold.

13. The method according to claim 2, wherein the first information comprises a received power of a signal or interference level related information, and the interference level related information comprises an interference power of a signal, and the selecting a channel access mechanism for an unlicensed band according to the first information comprises at least one of the following:
selecting, by the communication device, a Listen-Before-Talk (LBT) channel access mechanism in a consecutive tenth time period in a case that a received power of a signal of a communication peer is less than a twelfth threshold or an interference power of a signal of the communication peer is greater than a thirteenth threshold; or
selecting, by the communication device, a non-LBT channel access mechanism in a consecutive eleventh time period in a case that a received power of a signal of a communication peer is greater than a fourteenth threshold or an interference power of a signal of the communication peer is less than a fifteenth threshold.

14. A communication device, comprising:
a memory storing computer-readable instructions; and
a processor coupled to the memory and configured to execute the computer-readable instructions, wherein the computer-readable instructions, when executed by the processor, cause the processor to perform operations comprising:
obtaining first information; and
selecting a channel access mechanism for an unlicensed band according to the first information.

15. The communication device according to claim 14, wherein the first information comprises at least one of the followings:
statistical information of a channel’s historic state;
a transmission type or transmission priority;
feedback information of a Hybrid Automatic Repeat reQuest (HARQ) or a data retransmission ratio; or
a received power of a signal or interference level related information.

16. The communication device according to claim 15, wherein the statistical information of a channel’s historic state comprises at least one of the following:
a channel access success rate;
a channel access failure rate;
a channel occupancy rate; or
a cache data volume.

17. The communication device according to claim 14, wherein the communication device is a network side device, and selecting a channel access mechanism for an unlicensed band according to the first information comprises:
selecting the channel access mechanism for the unlicensed band for a terminal; and
after selecting the channel access mechanism for the unlicensed band for a terminal, the operations further comprise:
sending first indication information to the terminal, wherein the first indication information is used to indicate the channel access mechanism selected for the terminal in the unlicensed band.

18. The communication device according to claim 17, wherein the obtaining first information comprises:
receiving the first information reported by the terminal.

19. The communication device according to claim 14, wherein the operations further comprise:
sending second indication information to a communication peer, wherein the second indication information is used to explicitly or implicitly indicate to the communication peer a channel access mechanism for the communication device.

20. A non-transitory computer-readable medium storing instructions that, when executed by a processor, cause the processor to perform operations comprising:
obtaining, by a communication device, first information; and
selecting, by the communication device, a channel access mechanism for an unlicensed band according to the first information.
